(19) United States
(12) Patent Application Publication
(10) Pub. No.: US 2007/0000727 A1
(43) Pub. Date: Jan. 4, 2007

(54) Drain valve assembly

(76) Inventors: Sean V. Ciesielka, Belvidere, IL (US); Philip Lopresti, Chicago, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/390,889

(22) Filed: Mar. 28, 2006

Related U.S. Application Data
(60) Provisional application No. 60/695,598, filed on Jun. 30, 2005.

(51) Int. Cl. F16N 33/00

(52) U.S. Cl. 184/1.5

(57) ABSTRACT

Embodiments of the present invention provide a drain valve assembly configured for use with an engine. The drain valve includes an adapter configured to be secured to the engine, and an outlet tube moveably secured to the adapter. The outlet tube is configured to move with respect to the adapter.

### RELATED APPLICATIONS

This application relates to and claims priority benefits from U.S. Provisional Patent Application 60/695,598 entitled “Drain Valve,” filed Jun. 30, 2005, which is hereby incorporated by reference in its entirety.

### FIELD OF THE INVENTION

Embodiments of the present invention generally relate to a drain valve, and more particularly to a drain valve assembly that may be used with a small gas engine for lawn and garden equipment (such as lawnmowers and riding mowers), snowblowers, power shovels, generators, and the like.

### BACKGROUND OF THE INVENTION

FIG. 1 illustrates a conventional drain valve 10 connected to an oil sump 12. The drain valve 10 is a rigid metal pipe that provides little, if any, flexibility. The drain valve 10 is threadably secured to the oil sump 12 through a threaded end 14. In order to drain oil from the oil sump 12, an engagement end 16 of the drain valve 10 is rotated such that an oil passage (not shown) is exposed, thereby allowing oil to drain from the oil sump 12, through the drain valve 10, and out of the oil passage. Because the drain valve 10 is rigid and stiff, gaining access to the drain valve 10, and/or draining fluid therefrom, may be difficult. Additionally, because the drain valve 10 is rigid and stiff, if an outside object contacts the drain valve 10, the force exerted by the outside object may be sufficient to crack, snap, or otherwise break the drain valve 10 or the oil sump 12.

Thus, a need exists for a drain valve assembly that may be used with a small gas engine that is easy to access and use. Additionally, a need exists for a more resilient and robust drain valve assembly.

### SUMMARY OF THE INVENTION

Embodiments of the present invention provide a drain valve assembly configured for use with an engine. The drain valve assembly includes an adapter and an outlet tube.

The adapter may include a cylindrical body having a threaded end configured to be secured to a fluid outlet of an engine, and a tube-mating end including either a ball or a socket. An oil channel is formed through the adapter.

The outlet tube includes an adapter-mating end integrally formed with an intermediate portion, which is in turn integrally formed with an outlet end. The adapter-mating end includes an opposite one of the ball and socket as the adapter. That is, if the adapter includes the ball, the outlet tube includes the socket, and vice versa. An oil passage is formed through the outlet tube and is in fluid communication with the oil channel. The adapter-mating end is pivotally secured to the tube-mating end through the ball mating with the socket.

The outlet tube may also include a cap covering the outlet end. The cap is configured to be selectively moved between a closed position, in which the outlet end is closed, and an open position, in which the outlet end is open. The cap may be an elastomeric cap that is configured to be stretched into the open position, and/or the cap may be configured to be pulled or rotated into the open position.

### BRIEF DESCRIPTION OF SEVERAL VIEWS OF THE DRAWINGS

FIG. 1 illustrates a conventional drain valve connected to an oil sump.

FIG. 2 illustrates a lateral view of a drain valve assembly according to an embodiment of the present invention.

FIG. 3 illustrates a cross-sectional view of a drain valve assembly through line 3-3 of FIG. 2 according to an embodiment of the present invention.

FIG. 4 illustrates a lateral view of a drain valve assembly secured to an oil sump of a small engine according to an embodiment of the present invention.

FIG. 5 illustrates an isometric view of a drain valve assembly according to an embodiment of the present invention.

FIG. 6 illustrates an isometric view of a drain valve assembly according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

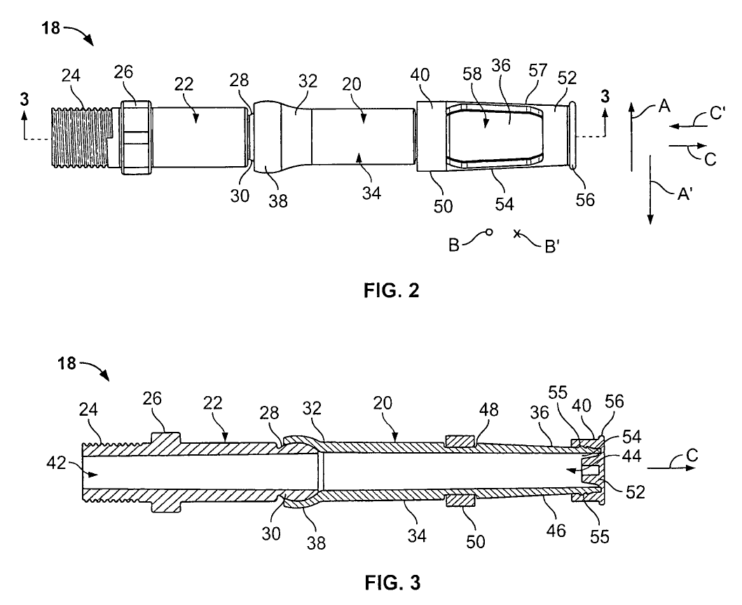

FIG. 2 illustrates a lateral view of a drain valve assembly 18 according to an embodiment of the present invention. The drain valve assembly 18 includes a resilient outlet tube 20 pivotally secured to an adapter pipe 22. The resilient outlet tube 20 may be formed of rubber or a solid plastic, such as glass-filled nylon, or the like, while the adapter pipe 22 may be formed of the a similar material, or cast metal (such as zinc).

The adapter pipe 22 includes a threaded end 24 integrally connected to a hex-nut 26, which is in turn integrally connected to a tube-mating end 28. The threaded end 24 is configured to be threadably secured to a structure, such as an oil sump (not shown in FIG. 2) of a small engine (not shown in FIG. 2). The hex-nut 26 is configured to receive a tool, such as a socket wrench, which may be used to securely torque the adapter pipe 22 into the oil sump. While the adapter pipe 22 is shown with the threaded end 24 and the hex-nut 26, the adapter pipe 22 may, alternatively, be secured to the oil sump through various other configurations and methods. For example, the adapter pipe 22 may be bonded to the oil sump.

The tube-mating end 28 of the adapter pipe 22 includes a ball 30 that is configured to snapably mate into a socket. An oil channel (not shown in FIG. 2) passes through the entirety of the adapter pipe 22.

The outlet tube 20 includes an adapter-mating end 32 integrally formed with an intermediate portion 34, which is in turn integrally formed with an outlet end 36. An oil passage (not shown in FIG. 2) is defined through the adapter-mating end, the intermediate portion 34, and the outlet end 36.

The adapter-mating end 32 includes a socket 38 that is configured to snapably secure to the ball 30. Once the socket 38 is secured to the ball 30, the outlet tube 20 may pivot about the ball 30 through a wide range of directions. For example, the adapter-mating end 32 may pivot about the ball 30 in the directions denoted by arrows A, A′, B, B′, and all combinations thereof. Thus, if an outside object contacts the outlet tube 20, the outlet tube 20 pivots, bends, or otherwise gives with respect to the adapter pipe 22.

The outlet end 36 includes an elastomeric cap 40. The cap 40 may be selectively moved between open and closed positions. For example, in order to move the cap 40 into an open position, such that oil may flow through the outlet end 36, the cap 40 is urged in the direction of arrow C.

FIG. 3 illustrates a cross-sectional view of the drain valve assembly 18 through line 3-3 of FIG. 2. As shown in FIG. 3, an oil channel 42 is formed through the adapter pipe 22 and is in fluid communication with an oil passage 44 formed through the outlet tube 20. The socket 38 of the outlet tube 20 is pivotally secured around the ball 30 of the adapter pipe 22. While the outlet tube 20 is shown having the socket 38, and the adapter pipe 22 is shown having the ball 30, the outlet tube 20 may, alternatively, include a ball, while the adapter pipe 22 may, alternatively, include a corresponding socket 38.

The outlet end 36 of the outlet tube 20 gradually tapers toward its distal end 46. An annular notch 48 is formed in the outlet tube 20 proximate the union of the outlet end 36 and the intermediate portion 34. A securing ring 50 of the cap 40 is secured within the notch 48. Thus, the notch 48 securely retains the cap 40 in a closed position. The notch 48 also ensures the cap 40 is not ejected from the outlet tube 20 when the cap is opened. The cap 40 also includes a plug 52 that plugs or otherwise closes an oil outlet 54 of the outlet tube 20 when the cap 40 is in the closed position.

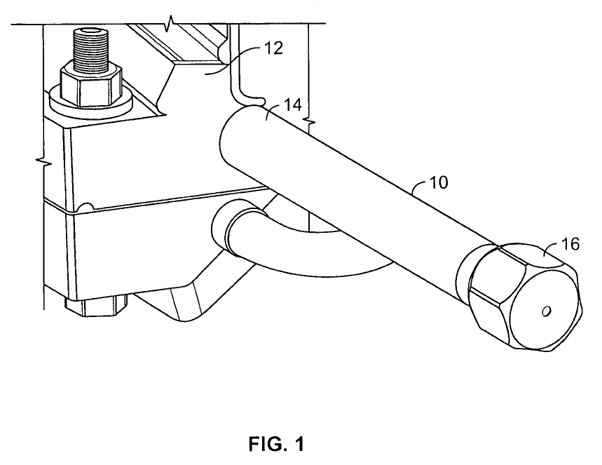

As discussed above with respect to FIG. 1, in order to open the outlet tube 20, the cap 40 is urged in the direction of arrow C. For example, the cap 40 may be grasped around a circumferential ledge 56 and pulled outward in the direction of arrow C. As the cap 40 is urged in this direction, the securing ring 50 may remain in the notch 48, but, because the cap 40 is formed of an elastomeric material, the cap 40 may be anchored in the notch 48, while it is stretched so that the plug 52 is removed from the oil outlet 54. Once the stretching force is no longer exerted, the cap 40 returns to its original, closed position. Alternatively, as the cap 40 is urged in the direction of arrow C, the securing ring 50 may follow, thereby dislodging from the notch 48. As such, the plug 52 is removed from the oil outlet 54, and oil may pass out of the oil outlet 54.

Referring to FIGS. 2 and 3, the cap 40 may include beams 57 that integrally connect the plug 52 to the securing ring 50. An opening 58 may be defined between the beams 57. The securing ring 50 may include a ridge (not shown) that abuts against a catch (not shown) formed around the oil outlet 54. Thus, the cap 40 may remain on the outlet tube 20, even when in the open position. If the cap 40 remains on the outlet tube 20 in the open position, oil may drain from the oil outlet 54 and through the opening 58. Optionally, the cap 40 may not include openings, but, instead, may be removable from the outlet end 36 in order to allow oil to drain from the oil outlet 54. In order to close the oil outlet 54, the cap 40 is urged in the direction of C′ until the securing ring 50 snapably secures into the annular notch 48, and the plug 52 closes the oil outlet 54. When the retaining ring 50 remains in the notch 48, the elastic force of the elastomer cap 40 holds the plug 52 on the outlet, thereby keeping the oil drain closed. Also, the outlet end 36 may include barbs or ridges 55 at a distal end that assist in retaining the plug 52 on the outlet 54. The ridges dig into the plug 52 to ensure that it remains firmly in place.

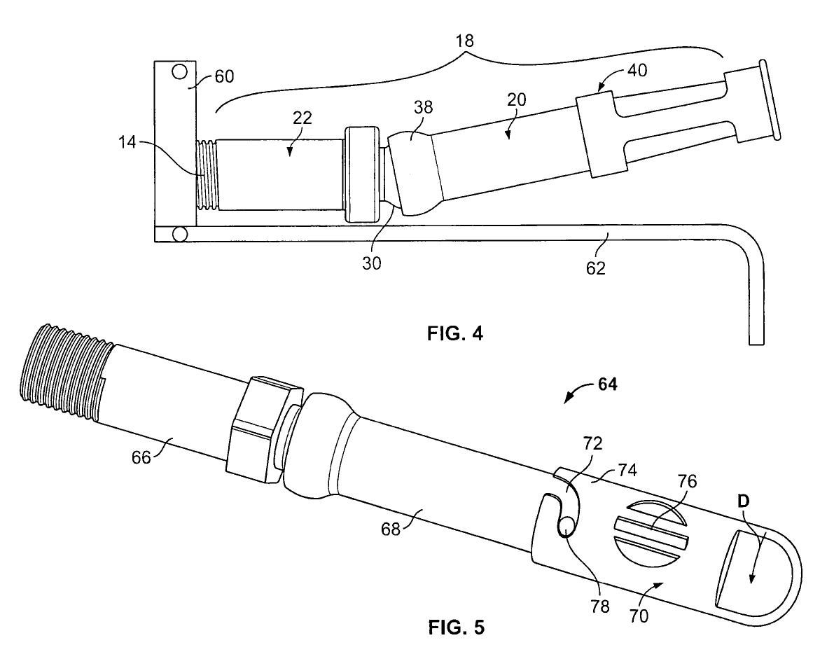

FIG. 4 illustrates a lateral view of the drain valve assembly 18 secured to an oil sump 60 of a device 62, such as an engine, or frame of a lawnmower or snowblower. The threaded end 14 of the adapter pipe 22 is threadably secured within a reciprocal oil outlet (not shown) of the oil sump 60. The socket 38 of the outlet tube 20 is pivotally secured about the ball 30 of the adapter pipe 22. Through this ball-and-socket connection, the outlet tube 20 may be pivoted through a variety of directions, such as described with respect to FIG. 2.

Oil may drain from the oil sump 60 into the oil channel 42 (shown in FIG. 3) of the adapter pipe 22. The oil then passes from the adapter pipe 22 into the oil passage 44 (shown in FIG. 3) of the outlet tube 20. In order to drain the oil from the drain valve assembly 18, the cap 40 is urged into the open position, as discussed above, thereby opening the oil outlet 54 (shown in FIG. 3). Thus, oil drains out of the drain valve assembly 18 through the oil outlet 54.

FIG. 5 illustrates an isometric view of a drain valve assembly 64 according to an embodiment of the present invention. The drain valve assembly 64 includes an adapter pipe 66, similar to the adapter pipe 22 (shown in FIGS. 2-4), that pivotally retains an outlet tube 68, similar to the outlet tube 20 (shown in FIGS. 2-4) in a similar fashion as that described above.

A cap 70 is disposed over the distal end of the outlet tube 68. The cap 70 is configured to rotate between open and closed positions. The cap 70 includes a curved channel 72 formed through an end 74 and a fluid opening 76. In order to move the cap 70 into an open position, such that fluid may drain from the outlet tube 68, the cap 70 is rotated in the direction of arc D. A post 78 extending outwardly from the outlet tube 68 and positioned through the channel 72 ensures that the cap 70 is not ejected from the outlet tube 68. Fluid may flow through the fluid opening 76 while in the open position. Optionally, the cap 70 may be in the open position as shown in FIG. 5, and, in order to move the cap 70 in the closed position, the cap is rotated in the direction of arc D.

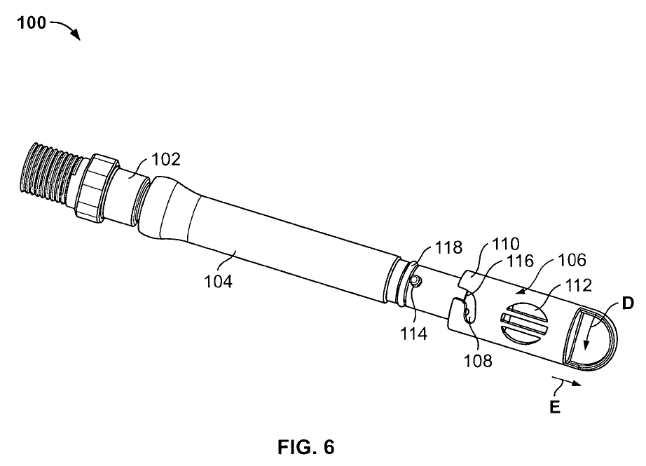

FIG. 6 illustrates an isometric view of a drain valve assembly 100 according to an embodiment of the present invention. The drain valve assembly 100 includes an adapter pipe 102, similar to the adapter pipe 22 (shown in FIGS. 2-4), that pivotally retains an outlet tube 104, similar to the outlet tube 20 (shown in FIGS. 2-4) in a similar fashion as that described above.

A cap 106 is disposed over the distal end of the outlet tube 104. The cap 106 is configured to be moved between open and closed positions. The cap 106 includes a curved channel 108 formed through an end 110 and a fluid opening 112. In order to move the cap 106 into an open position, such that fluid may drain from the outlet tube 104, the cap 106 is rotated in the direction of arc D and pulled in the direction of E. During this motion, the cap 106 is removed from the post 114. A retaining groove 116 formed around the outlet tube 104 ensures that the cap 106 is not ejected from the outlet tube 104 when the oil drain is open. That is, the cap 106 includes an interiorly-directed ridge (not shown) that is retained within the groove 116 to ensure that the cap 106 is not removed from the outlet tube 104. Additionally, a snap ring 118 is formed around the outlet tube 104 close to the center of the outlet tube 104 than the retaining groove 116. The snap ring 118 assists in retaining the cap 106 in the closed position by snapably securing the ridge (not shown) of the cap 106.

Embodiments of the present invention provide a drain valve assembly that may be pivoted, or otherwise moved, through a variety of positions. Additionally, embodiments of the present invention provide a resilient and robust drain valve assembly. Because of the ball-and-socket joint, if objects contact the drain valve assemblies discussed above, the assemblies will bend or give without breaking. Thus, a user may grasp and engage the drain valve assembly through a variety of positions and orientations. Overall, embodiments of the present invention provide a flexible drain valve assembly that is conveniently accessible and easy to use.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A drain valve assembly configured for use with an engine, the drain valve assembly comprising:
an adapter configured to be secured to the engine; and
an outlet tube moveably secured to said adapter, wherein said outlet tube is configured to move with respect to said adapter.

2. The drain valve assembly of claim 1, wherein said adapter comprises a tube-mating end having a ball, and wherein said outlet tube comprises an adapter-mating end having a socket, wherein said outlet tube is pivotally secured to said adapter through said ball mating with said socket.

3. The drain valve assembly of claim 1, wherein said adapter comprises a tube-mating end having a socket, and wherein said outlet tube comprises an adapter-mating end having a ball, wherein said outlet tube is pivotally secured to said adapter through said ball mating with said socket.

4. The drain valve of claim 1, wherein said outlet tube further comprises a cap covering a fluid outlet of said outlet tube, said cap configured to be selectively moved between a closed position, in which said fluid outlet is closed, and an open position, in which said fluid outlet is open.

5. The drain valve of claim 4, wherein said cap is an elastomeric cap that is configured to be stretched into the open position.

6. The drain valve of claim 4, wherein said cap is configured to be pulled into the open position.

7. The drain valve of claim 4, wherein said cap is configured to be at least one of rotated and pulled into the open position.

8. An engine assembly, comprising:
an oil sump comprising a sump outlet;
an adapter comprising a cylindrical body having a sump end secured within said sump outlet and a tube-mating end, an oil channel being formed through said adapter, said sump outlet being in fluid communication with said oil channel; and
an outlet tube comprising an adapter-mating end integrally formed with an intermediate portion, which is in turn integrally formed with an outlet end, an oil passage being formed through said outlet tube, said oil channel being in fluid communication with said oil passage, and said adapter-mating end being pivotally secured to said tube-mating end.

9. The engine assembly of claim 8, wherein said tube-mating end comprises a ball, and wherein said adapter-mating end comprises a socket, wherein said outlet tube is pivotally secured to said adapter through said ball mating with said socket.

10. The engine assembly of claim 8, wherein said tube-mating end comprises a socket, and wherein said adapter-mating end comprises a ball, wherein said outlet tube is pivotally secured to said adapter through said ball mating with said socket.

11. The engine assembly of claim 8, wherein said outlet tube further comprises a cap covering said outlet end of said outlet tube, said cap configured to be selectively moved between a closed position, in which said outlet end is closed, and an open position, in which said outlet end is open.

12. The engine assembly of claim 11, wherein said cap is an elastomeric cap that is configured to be stretched into the open position.

13. The engine assembly of claim 11, wherein said cap is configured to be pulled into the open position.

14. The engine assembly of claim 11, wherein said cap is configured to be at least one of rotated and pulled into the open position.

15. A drain valve assembly configured for use with an engine, the drain valve assembly comprising:
an adapter comprising a cylindrical body having an engine end configured to be secured to the engine, and a tube-mating end comprising one of a ball and a socket, an oil channel being formed through said adapter; and
an outlet tube comprising an adapter-mating end integrally formed with an intermediate portion, which is in turn integrally formed with an outlet end, said adapter-mating end comprising an opposite one of said ball and socket as said adapter, an oil passage being formed through said outlet tube, said oil channel being in fluid communication with said oil passage, and said adapter-mating end being pivotally secured to said tube-mating end through said ball mating with said socket.

16. The drain valve of claim 15, wherein said outlet tube further comprises a cap covering said outlet end, said cap configured to be selectively moved between a closed position, in which said outlet end is closed, and an open position, in which said outlet end is open.

17. The drain valve of claim 16, wherein said cap is an elastomeric cap that is configured to be stretched into the open position.

18. The drain valve of claim 16, wherein said cap is configured to be pulled into the open position.

19. The drain valve of claim 16, wherein said cap is configured to be at least one of rotated and pulled into the open position.

20. The drain valve of claim 15, wherein at least one of said adapter and said outlet tube is formed of at least one of glass-filled nylon and zinc.
